(19) United States
(12) Patent Application Publication
(10) Pub. No.: US 2014/0167980 A1
(43) Pub. Date: Jun. 19, 2014

(54) Cable Load Measuring Element With Radio Transmission Of The Measured Values

(71) Applicants: Stephan Sonneborn, Bad Laasphe (DE); Michael Mai, Dreis-Trefenbach (DE); Tanja Spengler, Netphan (DE)

(72) Inventors: Stephan Sonneborn, Bad Laasphe (DE); Michael Mai, Dreis-Trefenbach (DE); Tanja Spengler, Netphan (DE)

(21) Appl. No.: 14/000,330

(22) PCT Filed: Feb. 22, 2012
(86) PCT No.: PCT/EP2012/053010

§ 371 Date: Feb. 28, 2014

(30) Foreign Application Priority Data
Feb. 22, 2011 (DE) 10 2011 000 875.6

(51) Int. Cl. G08C 17/02

(52) U.S. Cl. CPC G08C 17/02
USPC 340/870.02

(57) ABSTRACT

Method for measuring cable loads in a mineshaft (2), comprising the steps: provision of cable load measuring elements (6) on the conveyor means, provision of a cableless transmitter for cable load measured values on the conveyor means (4), connected to the cable load measuring elements, provision of a cableless receiver (12) for cable load measured values at the level of the surface of the mineshaft, provided with an output interface, measurement of the cable loads on the conveyor means by means of the cable load measuring elements for generating cable load values; and transmission of the cable load values in a cableless fashion between the transmitter (10) and the receiver for cable load measured values; and evaluation by means of an evaluation program with specification of the correction values.

This invention refers to a method and a device for determination of the cable forces of a multiple-cable conveyor system and the evaluation of the cable loads with corrective specifications.

Conveyor systems are essential systems for any mine in this world by the use of which persons and material can be transported to the respective destinations in the mine that may easily be several thousand meters deep, such as is the case in the South-African gold mines.

The conventional setup of a conveyor system is such that there is a conveyor means (e.g. conveyorcage, skip or counter-weight) attached to the ends of the upper cables. By moving of the upper cable with the help of the driving disc, the conveyor means is moved through the shaft. Depending on the respective depth of the conveyor means, i.e. the length of the upper cables in the shaft, there may be different cable forces among the upper cables. These differences must be balanced out to warrant an even carrying capacity and thus even strain of the upper cables.

Cable loads as such can be measured by conventional cable load measuring elements at the attachment points of the upper cable to the conveyor means and/or the load carrier, such as resistance strain gauges or other suitable means that emit an electrical signal that corresponds to the respective cable load.

In conveyor systems in mines, the measured values of the cable load measuring elements are usually recorded manually, carried to the surface of the mine manually and there entered into a data processing system that is, in case of doubt, connected to an evaluation system.

The manual reading of cable load values, and manual transmission from the conveyor means where the cable loads are measured to the evaluation system where the values are entered into the system, is not only tedious but also prone to errors, which may be disastrous in the case of the intended use in mines.

To solve this problem, data transmission systems have been suggested in which cable load values as measured at the conveyor means are modulated onto a sinus oscillation that was transmitted through the upper cable and scanned from the upper cable at the surface of the shaft. However, it has become apparent that such systems are extremely unreliable and were unable to deliver the desired results regarding transmission safety.

Accordingly, there is still a high demand for a solution that enables reliable transmission of the cable loads measured at the conveyor means up the shaft to the surface and to an evaluation system.

To meet this demand, a method for measurement of cable loads in conveyor systems is disclosed with the steps of providing of cable load measuring elements in rope attachment above the conveyor means, connected to at least one wireless transmitter, providing of at least one wireless receiver for measured cable load values at the level of the mine surface, provided with an output interface, measuring of the cable loads on the conveyor means by the cable measuring elements to determine cable loads, and wirelessly transmitting of the cable load values from the transmitter to the receiver for measured cable load values. A method as described here offers the necessary safety in transmitting measured cable load values from the conveyor means to the surface of the shaft, with both human error and mechanical errors in transmission essentially being eliminated.

In a preferred embodiment of the invention, the measured cable load values are transmitted from the wireless receiver for measured cable load values through the output interface directly to an evaluation system to ensure that the measured cable load values are fed into the system without avoidable delay.

According to another preferred embodiment, a plurality of independent cable load measuring elements are provided to measure, and transmit between the wireless transmitter and receiver for measured cable load values, a corresponding plurality of independent cable load values. In a particularly preferred embodiment, one cable load measuring element per upper cable is provided.

While wireless transmission of the data upwards along the shaft, using laser beams or other comparable facilities, is conceivable, the preferred manner of wireless transmission is radio transmission, possibly directional radio transmission or WLAN. In case of greater depths, relay stations may be provided for the data to be transmitted that receive, possibly amplify and reemit the transmitted signal.

Additionally, a transmitter module can be provided on the conveyor means that comprises at least one transmission antenna for wireless transmission of the measured cable load values to the surface, and to which the cable load measuring element or the independent cable load measuring elements are connected. The transmitter module may also comprise an interface, possibly in the form of an additional close-range antenna, a USB interface, a Bluetooth interface or an infrared interface in order to be also able to provide the measured cable load values to a receiver that is disposed within the conveyor means, as in the case of a laptop computer, a handheld or the like.

Additionally, a device for measurement of cable loads of conveyor systems, comprising at least one cable load measuring element for installation at a conveyor means, at least one wireless transmitter for measured elevator cable load values for installation at the conveyor means, for connection to the cable load measuring element or elements; and at least one wireless receiver for measured cable load values for installation at the surface of the mine shaft, provided with an output interface for connection to an evaluation system, wherein this device may have all those properties that have already been described with respect to the method.

Further elements, features and advantages of the present invention become apparent from the following description of a preferred embodiment in conjunction with the enclosed drawings, wherein this description and the drawings merely are illustrative and are not to be understood in any manner as limiting.

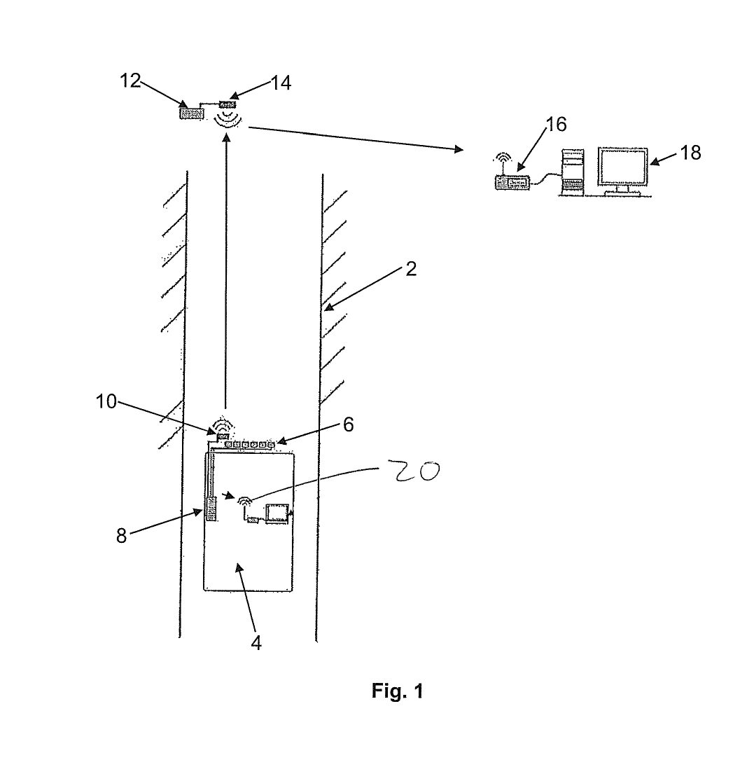

FIG. 1 shows a conveyor shaft 2 of a mine in which a conveyor means 4 can move up and down. The conveyor means 4 is attached to several upper cables (not illustrated) that can lower the conveyor means into the shaft or lift it up to the surface or the upper end of the shaft.

At the upper side of the conveyor means 4, one cable load measuring element 6 is provided per upper cable (not illustrated), by the use of which the respective cable load can be measured as a single, independent value for each measuring element. Determination of the cable loads takes place using a cable attachment in which the cable load measuring element is located.

The cable load measuring elements 6 are connected to a transmitter module 8, with each cable load measuring element 6 having a separate and dedicated connection to the transmitter module 8. The transmitter module 8 is connected to an antenna 10 on the conveyor means, which can transmit the read values of the cable load measuring elements 6 by radio transmission to a corresponding antenna 14 to a receiver 12 that is located at the upper end of the shaft. The transmitter module has six channels so that, in case of a number of more than six upper cables and therefore accordingly many cable load measuring elements, a correspondingly larger number of transmitter modules 8 must be provided.

In the embodiment, as displayed in the figure, the measured cable load values as received by the receiver 12 are in turn transmitted by radio transmission to an additional receiver 16, which is connected to an evaluation system 18, for calculation of the differences in the cable loads and illustration of the correction values for the cable length and/or the cable grooves of a cable carrier. The receiver 16 can therein also receive the measured values of more than one transmitter module 8. For the receiver 16 to be able to process more than the six channels of one transmitter module 8, each transmitter module 6 sends an ID before transmission of the six measured values so that the receiver can assign the transmitted measured values to the respective transmitter module 6. If there are several transmitter modules 6, the transmission of the respective six measured values then takes place sequentially, i.e. one transmitter module after the other.

FIG. 1 also shows that another receiver 20 can be disposed within the conveyor means 4 to receive the measured cable load values that are added to the transmitter module 8 by the cable load measuring elements 6.

1. A method for measurement of cable loads at upper cables in a conveyor shaft, comprising the steps:
providing cable load measuring elements on the conveyor means;
providing at least one wireless transmitter for measured cable load values in the conveyor means, connected to the cable load measuring elements;
providing at least one wireless receiver for measured cable load values at the level of the surface of the conveyor shaft, provided with an output interface;
measuring the cable loads on the conveyor means by the cable load measuring elements for determination of cable load values; and
wireless transmission of the cable load values between the transmitter and the receiver for measured cable load values.

2. The method according to claim 1, further comprising the step of transmitting the cable load values from the wireless receiver for measured cable load values through the output interface to an evaluation system.

3. The method according to claim 1, wherein a plurality of independent cable load measuring elements is provided on the conveyor means and a corresponding plurality of separate and independent cable load values is measured and transmitted between the transmitter and receiver for measured cable load values.

4. The method according to claim 3, wherein one independent cable load measuring element per upper cable is provided on the conveyor means.

5. The method according to claim 1, wherein the wireless transmission is a radio transmission.

6. The method according to claim 1, wherein one transmitter module is provided on the conveyor means, comprising at least one transmission antenna and to which the respective cable load measuring elements are connected.

7. The method according to claim 5, wherein the radio transmission is a directional radio transmission or WLAN.

8. The method according to claim 1, with the cable load measuring elements being integrated into a cable attachment.

9. A device for measurement of cable loads in a conveyor shaft, comprising: at least one cable load measuring element for installation in the conveyor means; at least one wireless transmitter for measured cable load values for installation at the conveyor means, connectable to the at least one cable load measuring element; and
at least one wireless receiver for measured cable load values for installation at the surface level of the mine shaft, provided with an output interface for connection to an evaluation system.

10. The device according to claim 9, wherein one independent cable load measuring element is provided per upper cable.

11. The device according to claim 9, wherein the wireless transmitter is a radio transmitter.

12. The device according to claim 11, wherein one transmitter module being provided for installation on the conveyor means that comprises at least one transmission antenna and that can be connected to the cable load measuring elements that are independent of each other.

13. The device according to claim 11, wherein the radio transmitter and receiver are a directional radio transmitter and receiver.

14. The device according to claim 11, wherein the radio transmitter and receiver are a WLAN transmitter and receiver.

15. The device according to claim 11, wherein the radio transmitter and receiver are a Bluetooth transmitter and receiver.

16. The device according to claim 9, wherein the cable load measuring elements are integrated into an cable attachment.
